(19) United States
(12) Patent Application Publication
(10) Pub. No.: US 2018/0248877 A1
(43) Pub. Date: Aug. 30, 2018

(54) METHOD AND DEVICE FOR TRANSMITTING IMAGE DATA

(71) Applicant: Skipapp GmbH, Duesseldorf (DE)

(72) Inventors: Felix HAAS, Duesseldorf (DE); Owen VERSTEEG, DELFT (NL)

(73) Assignee: Skipapp GmbH, Duesseldorf (DE)

(21) Appl. No.: 15/442,333

(22) Filed: Feb. 24, 2017

(51) Int. Cl. H04L 29/06; H04N 5/44

(52) U.S. Cl. CPC H04L 63/10; H04L 63/0876; H04N 5/44

(57) ABSTRACT

A method of processing image data comprising detecting, by a first device, a user input, capturing, at the first device, image data in response to the detection of the user input, sending, by the first device, the image data, upon capturing the image data, sending, by the first device, information either to access the image data for at least one second device while the at least one second device is in the vicinity of the first device, or not otherwise.

A method of processing image data comprising receiving, information about a first device, by at least one second device, wherein the information is for transferring image data to the at least one second device, in response to the receipt of the information about the first device, sending, by the at least one second device, a request to receive image data of the first device, receiving image data depending on information either to access the image data for the at least one second device while the at least one second device is in the vicinity of the first device, or not otherwise.

A method of processing image data comprising, receiving, by a server, image data from a first device, either sending, by the server, the image data to at least one second device or not, depending on information either to access the image data for the at least one second device while the at least one second device is in the vicinity of the first device, or not otherwise.

A first device, a second device, and a server for processing the image data.

### SPECIFICATION

The invention concerns methods and devices for transmitting image data.

A photo sharing process comprises taking pictures with friends, select friends and pictures that shall receive photos, sending the pictures by means of individually addressing the friends that shall receive an individual photo and send it via a Messenger, Email or other individual connection. Sharing is also possible with a predetermined group, e.g. by sending it to a group of friends or by an upload of photos to an online storage. However the addressees have to be notified about the image in this case individually as well. Sending photos in a single message to groups of friends is possible with some messengers or via Email, but the group of friends has to be defined in advance. This is impractical if composition of the photo shall be shared with persons actually on a photo or in case a photo shall be quickly shared with a new group of friends, e.g. in a one-time event, such as a wedding or conference.

It is therefore desirable to provide location-based photo sharing that allows users that are next to each other in a real life scenario to share photos with each other, instantly and effortlessly.

This goal is achieved by methods and devices according to the independent claims. Thus a one tap photo sharing is provided. That means as soon as a user presses a camera trigger to take a photo, the sharing process begins. Furthermore the sharing is location based. This means that devices around the device taking the photo are identified automatically, and the photo is sent in a few seconds to identified devices.

Further developments of the invention can be gathered from the dependent claims and the following description and drawings. In the drawings

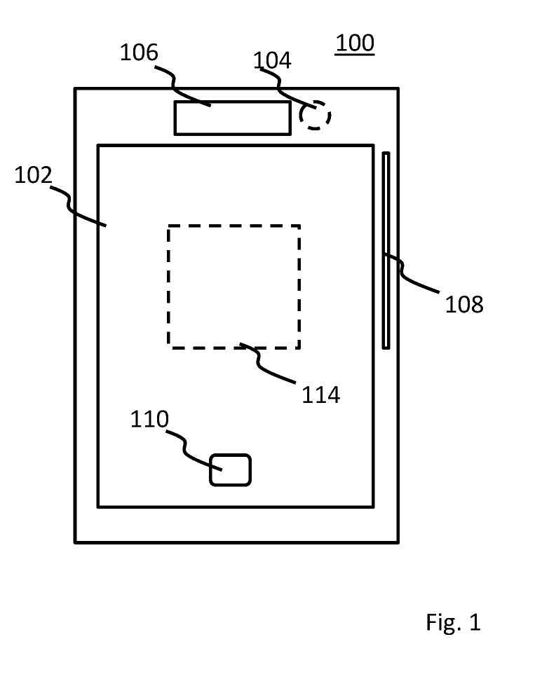

FIG. 1 depicts schematically parts of a first device for capturing image data,

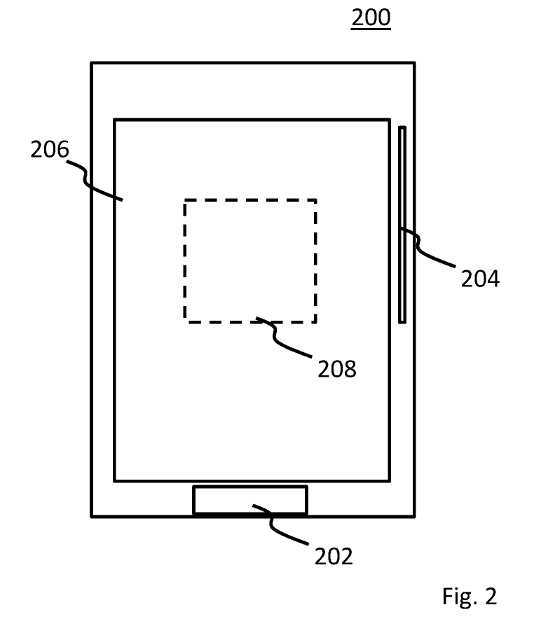

FIG. 2 depicts schematically parts of a second device for receiving image data,

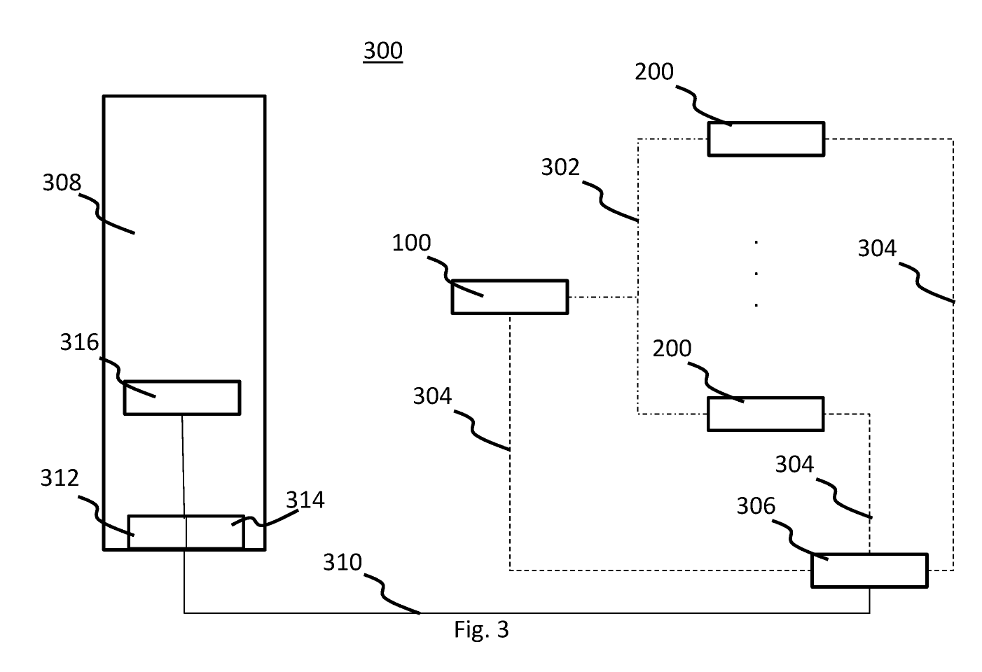

FIG. 3 depicts schematically parts of a communication network and a server,

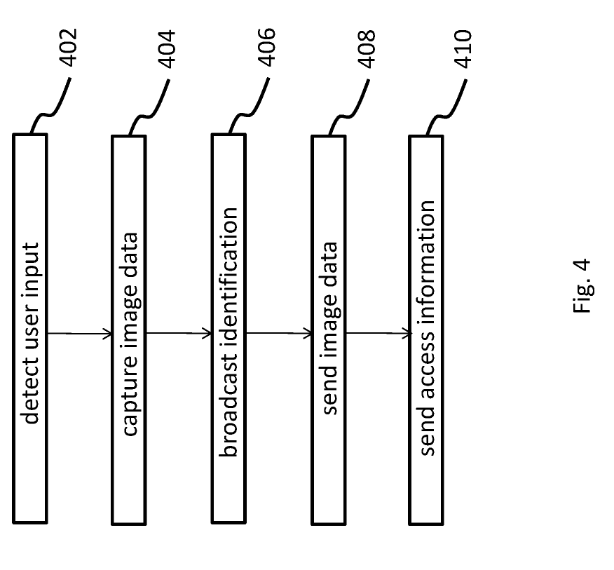

FIG. 4 depicts steps of a method for sending image data,

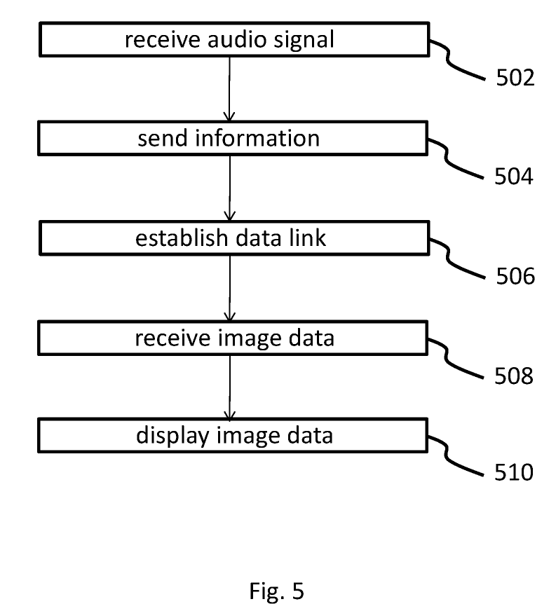

FIG. 5 depicts steps of a method for receiving image data,

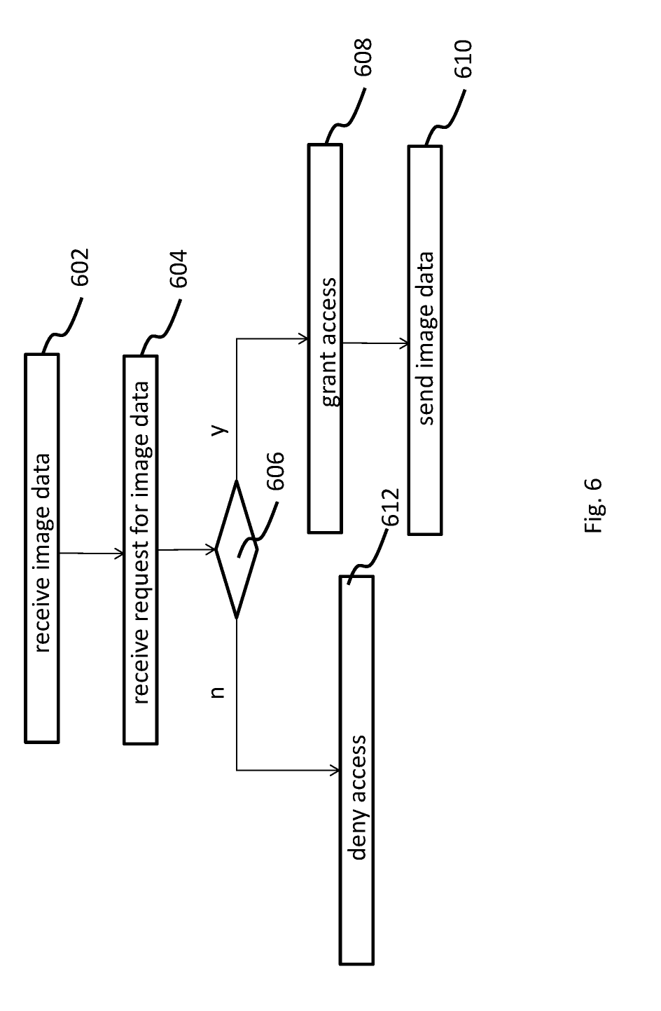

FIG. 6 depicts steps of a method for processing image data.

The following description and drawings illustrates the principles of the invention. Although not explicitly described or shown herein, various arrangements embody the principles of the invention and are included within its spirit and scope.

FIG. 1 depicts a first device 100 for capturing image data that comprises a human machine interface 102 configured to detect a user input, an image capturing unit 104 configured to capture image data in response to the detection of the user input, a sender 106 configured to broadcast an audio signal including information for transferring the image data in response to the detection of the user input.

The image capturing unit 104 is for example a camera module. The first device 100 is for example a smart phone comprising the camera module. The sender 106 comprises for example a speaker. Preferably the speaker of the smart phone is used. The first device 100 may be a camera without phone as well.

The human machine interface 102 comprises for example a touch screen display and a virtual or mechanical switch to trigger capturing of images by the camera module. In the example, the human machine interface 102 displays a box 110 and detects the user input when the box 110 is touched, e.g. by a finger or touch pen. When the box 110 is displayed, the human machine interface 102 may display a live image captured by the capturing unit 104.

The first device 100 comprises a first transmitter 108 operable for radio communication and a first processing unit 114 for operating the first device 100 according to an operating system. The operating system is for example Android OS version 6.0-6.0.1 (Marshmallow) or version 7.0-7.1.1 (Nougat) or another version of Android OS. Likewise the operating system may be iOS 9 or another version of iOS. The operation of the human machine interface 102, the capturing unit 104, the speaker and the first transmitter 108 is controlled by the operating system.

The audio signal is preferably a signal having a frequency inaudible for humans. The audio signal frequency is preferably above 15 kHz. The audio signal is for example at an ultrasonic frequency. The speaker is operable to output the audio signal. The sender 106 comprises a first driver for driving the speaker to output the audio signal comprising the information for transferring image data.

FIG. 2 depicts a second device 200 as an exemplary remote device. The second device 200 comprises a receiver 202 configured to receive the audio signal including information for transferring image data from the first device 100. The second device 200 comprises a second transmitter 204. The second device 200 comprises a display 206 for displaying image data. The second device 200 comprises a second processing unit 208. The second device 200 is for example another smart phone operating the second processing unit 208, the receiver 202, the display 206 and the second transmitter 204 according to one of the aforementioned operating systems. The receiver 202 comprises for example a microphone. Preferably the receiver 202 is the microphone of the other smart phone.

FIG. 3 depicts part of a communication network 300 comprising the first device 100 and at least one second device 200. The connectivity of the first device 100 and the second device 200 is described below referencing FIG. 3.

The sender 106 of the first device 100 is configured to broadcast the audio signal comprising an identification of the first device 100 as information for transferring image data. The receiver 202 of the at least one second device 200 is configured to receive the identification of the first device 100 as the information for transferring the image data.

Alternatively or additionally, the sender 106 is configured to broadcast an address of the first device 100 as the information for transferring the image data. In this case the receiver 202 is configured to receive an address of the first device 100 as the information for transferring the image data.

The receiver 202 comprises for example the microphone, operable to receive the audio signal. The receiver 202 comprises a second driver for driving the microphone to detect the audio signal and re-generate the information for transferring image data.

The first transmitter 108 of the first device 100 is configured to establish a connection via a radio data link 304. The second transmitter 204 is configured to send the information about the first device 100 via the radio data link 304.

The radio data link 304 is in the example via a network access point 306. In this case the second sender 204 is configured to send the information about the first device 100 via the network access point 306. For example the network access point is configured to route or otherwise forward the information to a server 308 via a data link 310. The connection between the server 308 and the network access point 306 is for example via a telecommunication network.

The server 308 comprises a receiver 312 and a sender 314 configured for establishing connections via the telecommunication network, i.e. via the data link 310. The server 308 comprises a processor 316 configured to process the information about at least one second device 200 to route or otherwise forward the image data once it is received from the first device 100.

The information about the first device 100 identifies any of the at least one second device 200 that are in vicinity of the first device 100. More specifically, any of the at least one second device 200 that is within range of the first device 100 to receive the audio signal, is considered in the vicinity of the first device 100.

The server 308 is adapted to allow access to the image data or not depending on whether the at least one second device 200 is in vicinity of the first device. This means that the image data is routed or forwarded otherwise to the at least one second device 200, if the processor 316 determines that the first device 100 and the at least one second device 200 are within a predetermined geographic area. Instead of using audio signals to determine the range, a global positioning system signal, a Bluetooth or near field communication signal or other geo-location based technique may be used to determine that at least one other device is in vicinity. The at least one second device 200 receives information about the first device 100 only when it is nearby. The image data is accessed only, for the at least one second device 200 when it sends the request with the identification of the first device 100 within a certain period of time after the image data was captured by the first device 100 or sent to the server 308. This way the server 308 learns which at least one second device 200 shall receive the image data based on vicinity.

The server 308 is configured to determine one of the at least one second device 200 or a plurality of the at least one second device 200 depending on the information about the at least one first device 100, and to send the image data addressed to the determined at least one second device 200 or to the determined plurality of the at least one second device 200 respectively. The first device 100 is configured to send the image data to the server 308 upon capturing the image data. The image data is sent without further user interaction. This means that the image is sent automatically after it is captured. The user input that triggers capturing of the image is the only input required to share the image.

The first device 100 is configured to send the image data addressed to the server 308 via the network access point 306. The server 308 is configured to route or otherwise forward the image data to the at least one second device 200. The server 308 is configured to send the image data addressed to the at least one second device 200. This way, the first device 100 may send the image data only once to the server 308 and the server 308 sends the image to any of the at least one second device 200. Only the at least one second device 200 that is within the range to receive the audio signal receives the image data. This means image data is shared only with devices that are close to each other. Because the server 308 is used to process the image data, an additional filter may be implemented in the server 308 to optionally allow sending or block sending of image data to any remote devices depending on a filter list. The server 308 for example comprises a data base that maps devices to the filter options.

The at least one second device 200 is configured to establish a data link to the server 308, and to receive the image data from the server 308. The data link may be initiated by the second device 200 automatically upon receipt of the audio signal, or by the server 308 upon receipt of the request for image data.

A method of sending the image data is described below referencing FIG. 4.

When method starts, according to the example, a corresponding application implementing steps of the method is running on the first device 100 and the at least one second device 200.

The application on the first device 100 is constantly, repeatedly or intermittently broadcasting the audio signal including the information for transferring the image data when the application is running. In a variation of the method, the application on the first device 100 is constantly, repeatedly or intermittently broadcasting the audio signal including the information for transferring the image data when the application is switched off. For example the identification or address of the first device 100, i.e. the device for capturing the image data, is broadcast. The audio signal preferably has a frequency inaudible for humans as described above.

After the start, a step 402 comprises detecting, at the first device 100, a user input.

In response to the detection of the user input a step 404 is executed.

Step 404 comprises capturing, at the first device 100, image data.

In response to the detection of the user input, an optional step 406 is executed. Step 406 is processed for example in parallel to capturing the image, or as depicted in FIG. 4 after capturing the image in step 404. Optional step 406 is executed without additional user input or after successful confirmation in a user dialog processed by the human machine interface 102.

Optional Step 406 comprises broadcasting, by the first device 100, the audio signal including the information for transferring the image data. For example the identification or address of the first device 100, i.e. the device for capturing the image data is broadcast. As mentioned above the broadcast is repeated preferably constantly, repeatedly or intermittently when the application is running and sometimes when it is switched off.

Afterwards a step 408 is executed.

Step 408 comprises sending, by the first device 100, the image data to the server 308.

Afterwards a step 410 is executed.

Step 410 comprises sending, by the first device 100, information either to access to the image data for at least one second device 200 while the at least one second device 200 is in the vicinity of the first device, or not otherwise. In the example, the identification of the first device 100 is sent as this information. The identification may be a unique alphanumeric identification, a number, a name or the like. The sending of image data and of the information may be a single step. The information may be encoded with the image data.

Afterwards the method ends.

Notably, no addressing of the image data to individual devices is required to share image data. Preferably the address of the server 308 is known statically, or received via a domain name server. The first device 100 requires no information about any of the at least one second devices to share the image data. The image data is shared only with the devices in vicinity. This provides an easy one touch solution of image sharing. The further processing is as described below.

A method of receiving the image data by at least one second device 200 is described below referencing FIG. 5.

A step 502 comprises receiving, at the at least one second device 200, an audio signal including information for transferring image data from the first device 100. For example the identification or the address of the device for capturing the image data is received as the information for transferring the image data. The application on the at least one second device 200 is constantly, repeatedly or intermittently listening for the audio signal including the information for transferring the image data when the application is running. In a variation of the method, the application on the at least one second device 200 is constantly, repeatedly or intermittently listening for the audio signal including the information for transferring the image data when the application is switched off. For example the identification or address of the first device 100, i.e. the device for capturing the image data, is received this way.

In response to the receipt of the audio signal a step 504 is executed.

Step 504 comprises, sending information about the at least one first device 100 to the server 308. The information is sent via the radio data link in particular via the network access point 306.

For example the identification or the address of the first device 100 is sent as the information about the first device.

Afterwards a step 506 is executed.

In step 506 a data link is established. For example a data link to the server 308 is established. This link is established without user interaction or after successful execution of a confirmation user dialog.

The data link is established for receiving image data when the at least one second device 200 accesses the image data while the at least one second device 200 is in the vicinity of the first device 100. With this regard, FIG. 5 depicts the method of a successful access. When access is denied, the method ends, e.g. by a time out or upon receipt of a corresponding information from the server 308.

After step 506 a step 508 is executed.

In step 508 image data is received. The image data is received from the server 308.

Afterwards an optional step 510 is executed to display the received image data.

Afterwards the method ends.

A method of processing the image data at the server 308 is described below referencing FIG. 6.

A step 602 comprises receiving image data from the first device 100. In this step, a data link is establishing between the server 308 and the first device 100. The server 308 learns information about the first device 100 and stores the received image data assigned to the information about the first device 100, e.g. in a data base.

Afterwards a step 604 is executed.

In step 604, a request for image data is received from at least one second device 200. Multiple requests may be received in parallel or one after the other. The request contains the information about the first device 100, i.e. the address or identification. The request may contain information about the requesting at least one second device 200, e.g. an address or identification.

Step 604 comprises receiving the information about the first device 100.

Afterwards a step 606 is executed. In step 606 the information about the first device 100 is processed to determine the information either to access the image data for the at least one second device 200 while the at least one second device 200 is in the vicinity of the first device 100, or not otherwise, depending on the request. More specifically, the information about the first device 100 is matched to the image data received in step 602. For example a data base lookup for the information about the first device 100 received in step 604 reveals image data assigned to the information about the first device 100.

If the data base lookup was successful, a step 608 is executed. Otherwise a step 612 is executed.

In step 612 the image data is not accessed. Afterwards the method ends. A response indicating the result may be sent to the at least one second device 200 optionally.

Step 608 comprises accessing by at least one second device 200. This means that access for the at least one second device 200 is established if the image data is found.

Afterwards a step 610 is executed to send the image data. The server 308 for example routes or otherwise forwards the image data to the at least one second device 200.

Sending is for example based on the address information received in step 604, i.e. in the request, or by a mapping of identification received in step 604 to an address already stored in the server 308 for establishing the link.

Sending may include sending the image data addressed to the at least one second device 200.

This means either sending the image data to at least one second device 200 or not, depending on information either to access the image data for the at least one second device while the at least one second device is in the vicinity of the first device, or not otherwise.

Afterwards the method ends.

More specifically steps 608 and 610 may comprise determining a plurality of at least one second device 200 depending on the information about the at least one first device 100, and sending the image data to the plurality of at least one second device 200. The image data is in this case addressed by the server 308 depending on information about the plurality of at least one second device 200. The server 308 is configured for sending the image data addressed to the plurality of the at least one device 200 individually.

The additional filter may be implemented in the server 308 to optionally allow sending or block sending of image data to any of the at least one second device 200 depending on a filter list. The server 308 for example comprises a data base that maps devices to the filter options. This way sharing of the image data may be cancelled for certain or all devices.

The transmission of image data may be aborted at the first device 100 or the at least one second device 200 by a corresponding cancel function. To this end a corresponding user interaction may be requested and detected.

When other geo-location information regarding the device is available, the sending of the audio signal may be omitted. Instead the server 308 may track the geo-location of devices and determine the devices for receiving the data automatically when the trigger for capturing the image data is detected at the first device 100.

1. A method of processing image data, comprising
detecting, by a first device, a user input,
capturing, by the first device, image data in response to the detection of the user input,
sending, by the first device, the image data, upon capturing the image data,
sending, by the first device, information either to access the image data for at least one second device while the at least one second device is in the vicinity of the first device, or not otherwise.

2. The method of claim 1, comprising
broadcasting, by the first device, an identification of the first device for capturing the image data as information for transferring the image data constantly, repeatedly, intermittently or upon capturing the image data.

3. The method of claim 1, comprising
broadcasting, by the first device, an address of the first device as the information for transferring the image data constantly, repeatedly, intermittently or upon capturing the image data.

4. A first device, comprising
a human machine interface configured to detect a user input, and an image capturing unit configured to capture image data in response to the detection of the user input,
a transmitter configured to send the image data in response to the detection of the user input,
wherein the transmitter is configured to send information either to access the image data for at least one second device while the at least one second device is in the vicinity of the first device, or not otherwise.

5. The first device of claim 4, comprising
a sender configured to broadcast an identification of the first device as the information for transferring the image data.

6. The first device of claim 4, comprising
a sender configured to broadcast an address of the first device as the information for transferring the image data.

7. A method of processing image data, comprising
receiving, information about a first device, by at least one second device, wherein the information is for transferring image data to the at least one second device,
in response to the receipt of the information about the first device, sending, by the at least one second device, a request to receive image data of the first device,
receiving image data depending on information either to access to the image data for the at least one second device while the at least one second device is in the vicinity of the first device, or not otherwise.

8. The method of claim 7, comprising
sending an identification of the first device in the request to receive image data of the first device.

9. The method of claim 7, comprising
sending an address of the first device in the request to receive image data of the first device.

10. The method of claim 7, comprising
receiving an identification of the first device as the information for transferring the image data.

11. The method of claim 7, comprising
receiving an address of the first device as the information for transferring the image data.

12. The method of claim 7, comprising
establishing a data link to a server, receiving the image data from the server.

13. A second device, comprising
a receiver configured to receive, information about a first device, wherein the information is for transferring image data to at least one second device,
a transmitter configured to send, in response to the receipt of the information about the first device, a request to receive image data of the first device,
wherein receiving image data depends on information either to access the image data for at least one second device while the at least one second device is in the vicinity of the first device, or not otherwise.

14. The second device of claim 13, wherein
the transmitter is configured to send an identification of the first device in the request to receive image data of the first device.

15. The second device of claim 13, wherein
the transmitter is configured to send an address of the first device in the request to receive image data of the first device.

16. The second device of claim 13, wherein
the receiver is configured to receive an identification of the first device as the information for transferring the image data.

17. The second device of claim 13, wherein
the receiver is configured to receive an address of the first device as the information for transferring the image data.

18. The second device of claim 13, wherein the second device is configured to
establish a data link to a server, and to receive the image data from the server.

19. A method of processing image data comprising,
receiving, by a server, image data from a first device,
either sending, by the server, the image data to at least one second device or not, depending on information either to access the image data for the at least one second device while the at least one second device is in the vicinity of the first device, or not otherwise.

20. The method of claim 19, comprising
receiving, by the server, a request to receive image data of the first device from the at least one second device,
determining, by the server, the information either to access the image data for the at least one second device while the at least one second device is in the vicinity of the first device, or not otherwise, depending on the request.

21. A server for processing image data, comprising
a receiver configured to receive image data from a first device,
a sender configured to either send the image data to at least one second device or not, depending on information either to access the image data for the at least one second device while the at least one second device is in the vicinity of the first device, or not otherwise

22. The server of claim 21, wherein
the receiver is configured to receive a request to receive image data of the first device from the at least one second device,
the server comprising a processor configured to determine the information either to access the image data for the at least one second device while the at least one second device is in the vicinity of the first device, or not otherwise, depending on the request.
